(19) United States
(12) Patent Application Publication
(10) Pub. No.: US 2026/0351658 A1
(43) Pub. Date: Nov. 5, 2026

(54) CLAMPING TRAY AND METHOD FOR OPERATING CLAMPING TRAY

(71) Applicant: SK On Co., Ltd., Seoul (KR)

(72) Inventors: Jae Hyeok YU, Daejeon (KR); Eun Sol KO, Daejeon (KR); Dong Yeop CHU, Daejeon (KR)

(21) Appl. No.: 19/658,708

(22) Filed: Apr. 27, 2026

(30) Foreign Application Priority Data
Apr. 30, 2025 (KR) 10-2025-0057527
Dec. 9, 2025 (KR) 10-2025-0194288

(51) Int. Cl. H01M 10/04; B30B 9/00

(52) U.S. Cl. CPC H01M 10/0481; B30B 9/00

(57) ABSTRACT

Proposed is a clamping tray and a method for operating the clamping tray, wherein the clamping tray includes a tray body having a support part capable of supporting a plurality of objects, a road cell provided across the support part of the tray body and capable of measuring a pressure, and a pressing unit configured to press the plurality of objects supported by the support part from opposite ends of the tray body toward the road cell.

### CROSS REFERENCE TO RELATED APPLICATION

The present application claims priority to Korean Patent Application No. 10-2025-0057527, filed Apr. 30, 2025, and Korean Patent Application No. 10-2025-0194288, filed Dec. 09, 2025, the entire contents of which are incorporated herein for all purposes by this reference.

### BACKGROUND OF THE INVENTION

### FIELD OF THE INVENTION

The present disclosure relates to a clamping tray and a method for operating the clamping tray.

### DESCRIPTION OF THE RELATED ART

Due to the rapid advancement of industries such as electronics and telecommunications, high-powered lithium-ion batteries are widely used in portable electronic devices like mobile phones and laptops, power tools requiring high output and high power, and medium and large-sized devices such as electric bicycles and automobiles.

Such lithium secondary batteries may be classified by shape into cylindrical batteries, prismatic batteries, pouch batteries, etc., and by electrolyte type into lithium-ion secondary batteries, lithium-ion polymer batteries, lithium polymer batteries, etc.

The manufacturing process for lithium secondary batteries is broadly divided into the electrode, assembly, and activation processes. The activation process includes the HVC (heat vacuum charge) process, which activates a battery by heating, compressing, and charging battery cells.

### SUMMARY OF THE INVENTION

Accordingly, an objective of the present disclosure is to provide a clamping tray capable of improving the contact precision between battery cells and preventing positional distortion caused by battery cell expansion, and a method for operating the clamping tray.

Another objective of the present disclosure is to provide a clamping tray capable of being widely used in green technology fields such as electric vehicles and battery charging stations, and solar and wind power generation, and a method for operating the clamping tray.

According to the embodiment of the present disclosure, there is provided a clamping tray including: a tray body having a support part capable of supporting a plurality of objects; a road cell provided across the support part of the tray body, and capable of measuring pressure; and a pressing unit configured to press the plurality of objects supported by the support part from opposite ends of the tray body toward the road cell.

The tray body may include: a frame forming an outer frame; and a partition unit arranged across a central portion of the frame from a first side to a second side and dividing an inner space of the frame into two spaces.

The road cell may be secured across the frame perpendicular to the partition unit, and configured to measure pressure on opposite sides.

The road cell may be divided into a plurality of measurement units, and each measurement unit may be configured to individually measure pressure.

The plurality of measurement units may include four measurement units to uniformly quarter the road cell.

The pressing unit may be provided at one of both end portions of the tray body, spaced apart from another pressing unit, and include a plurality of power units.

The plurality of power units may include four power units to correspond to the measurement units, and may be arranged symmetrically on a central portion of an end of the tray body.

The plurality of power units may be operated individually from each other.

The clamping tray may further include: a rotating shaft receiving rotation power from each of the power units and having screw threads on a circumferential surface and extending from a first end portion to a second end portion of the tray body.

The clamping tray may further include: a movable pressing unit connected to each of a first end portion and a second end portion of the rotating shaft, and configured to move toward each other or in opposite directions by the rotating power of the rotating shaft.

According to the embodiment of the present disclosure, there is provided a method for operating a clamping tray, the method including: accommodating objects by a support part of a tray body while arranging the objects symmetrically in both sides of a road cell; pressing, by the pressing unit, the objects supported by the support part from both end portions of the tray body toward the road cell; measuring, by the road cell, pressure exerted on the objects pressed at either side of the road cell; and adjusting the power of the pressing unit according to the pressure measured by the road cell, and pressing the objects.

The measuring of pressure may be performed by measuring, by the plurality of measurement units of the road cell, partial pressures corresponding to each object pressed by the pressing unit.

The adjusting of power may be performed by adjusting the power of the plurality of power units of the pressing unit differently according to the partial pressures measured by the plurality of measurement units, thereby pressing the object.

The adjusting of power may be performed by increasing the power of one power unit that supplies the pressure to a portion of the object where a partial pressure of the object measured by the plurality of measurement units may be lower than other portions, and by lowering the power of another power unit that supplies the pressure to a portion of the object where a partial pressure of the object measured by the plurality of measurement units may be higher than other portions, thereby adjusting the entire flatness of the object uniformly.

The features and advantages of the present disclosure will be more apparent from the following detailed description based on the accompanying drawings.

Further, it should be noted that the terms and words used in the specification and the claims should not be construed as being limited to ordinary meanings or dictionary definitions, and should be interpreted as having a meaning and a concept that are consistent with the technical idea of the present disclosure based on the principle that an inventor may appropriately define the concept of a term to best describe the present disclosure of the inventor.

According to an embodiment of the present disclosure, it is possible to reduce pressurization cumulative errors.

According to the embodiment of the present disclosure, it is possible to reduce pressurization control errors and the pressurization control time.

According to the embodiment of the present disclosure, it is possible to improve the pressure precision.

According to the embodiment of the present disclosure, it is possible to reduce depressurization errors.

According to the embodiment of the present disclosure, it is possible to reduce depressurization deviation.

### BRIEF DESCRIPTION OF THE DRAWINGS

FIG. 1 is a plan view schematically showing a clamping tray according to an embodiment of the present disclosure.

FIG. 2 is a view schematically showing a support part of the clamping tray according to the embodiment of the present disclosure.

FIG. 3 is a view showing a road cell of the clamping tray according to the embodiment of the present disclosure.

FIG. 4 is a front view showing the clamping tray shown in FIG. 1.

FIG. 5 is a flowchart showing a method for operating the clamping tray according to the embodiment of the present disclosure.

### DETAILED DESCRIPTION OF THE DISCLOSURE

The terminology used to describe embodiments of the present disclosure is not intended to limit the present disclosure. It should be noted that expressions in singular may include expressions in plural unless the context clearly indicates otherwise.

In assigning reference numerals to components of the drawings, it should be noted that the same components are given the same reference numerals as much as possible even when they are shown in different drawings, and similar reference numerals are given to similar components.

The drawings may be schematic or exaggerated to illustrate embodiments. In the present document, expressions such as “has”, “may have”, “comprises”, “may comprise”, “includes”, or “may include” indicate the presence of corresponding characteristics (e.g., a numerical value, function, operation, or component such as a part), and does not exclude the presence of additional characteristics.

Terms such as “one”, “other”, “another”, “first”, “second”, etc. are used to distinguish one component from another, and components are not limited by the above terms.

A clamping tray may be used mainly in battery cell fabrication processes.

The clamping tray may be used in a heat vacuum charge process of battery cell fabrication processes.

The clamping tray may maintain stably the position and shape of electric cells at high temperature and vacuum condition, and maximize electrolyte supply and gas removal efficiency.

That is, the clamping tray is custom-designed to accommodate battery cell types (prismatic, pouch-type, etc.) to secure the battery cells and provide structural support, thereby preventing expansion and deformation of the battery cells under heating and vacuum conditions.

Hereinbelow, with reference to accompanying drawings, an embodiment of the present disclosure will be described in detail.

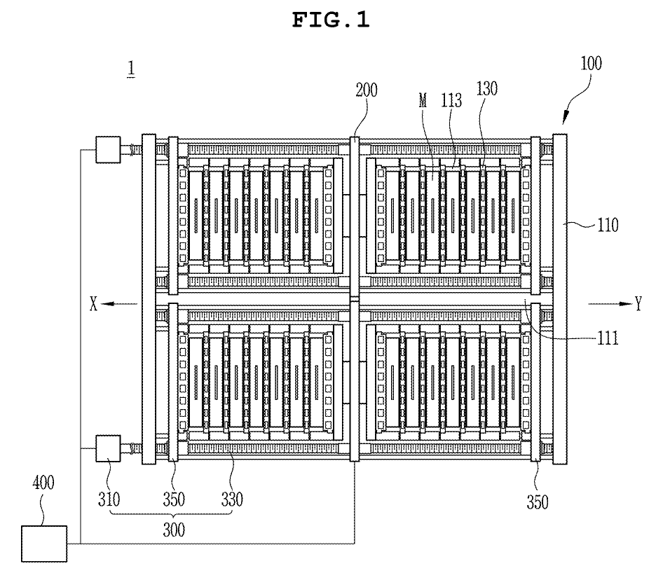

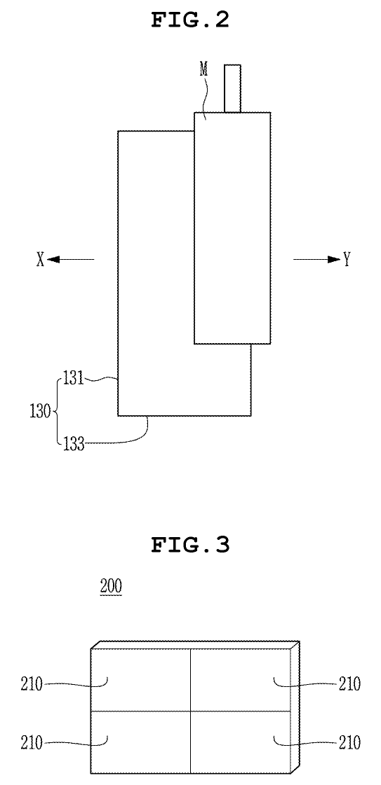

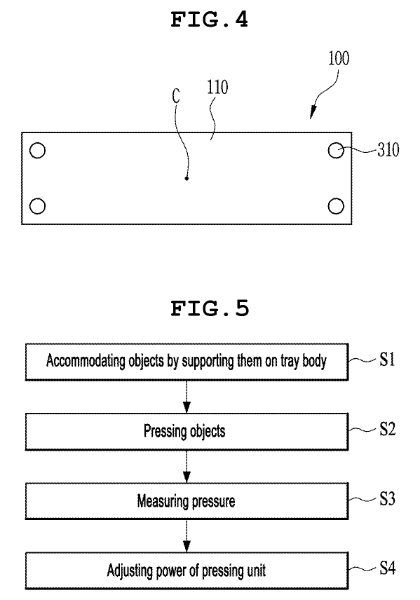

FIG. 1 is a plan view schematically showing a clamping tray according to an embodiment of the present disclosure. FIG. 2 is a view schematically showing a support part of the clamping tray according to the embodiment of the present disclosure. FIG. 3 is a view showing a road cell of the clamping tray according to the embodiment of the present disclosure. FIG. 4 is a front view showing the clamping tray shown in FIG. 1.

As shown in FIG. 1, according to the embodiment of the present disclosure, a clamping tray 1 may include a tray body 100 including a support part that may support a plurality of objects M, a road cell 200 arranged across the support part of the tray body 100 and capable of measuring pressure, and a pressing unit 300 pressing the plurality of objects M supported by the support part from both end portions of the tray body 100 toward the road cell 200.

The clamping tray 1 may accommodate a plurality of objects M, such as a plurality of battery cells, and simultaneously, press them while supporting them.

The tray body 100 may form the body of the clamping tray 1.

The tray body 100 may include a frame 110 and a support part 130.

The frame 110 may form an outer frame of the tray body 100.

The frame 110 may be a rectangular frame with a central hollow space.

Furthermore, the frame 110 may include a partition unit 111 arranged across the central portion from one side (X-side) to the other side (Y-side).

The partition unit 111 may divide the central space formed through an inner space of the frame 110 into two spaces.

The frame 110 may include a plurality of moving guides 113 arranged across the central hollow space.

The plurality of moving guides 113 may be connected perpendicularly to the partition unit 111 and extend to an X-directional end portion or a Y-directional end portion of the frame 110.

The moving guides 113 may be spaced apart from each other at predetermined intervals and arranged within the central hollow space of the frame 110.

The support part 130 may be provided in the frame 110 to be linearly movable toward one side (X-side), and the other side (Y-side) along the moving guides 113.

The support part 130 may be provided to be slidably movable in each of the two inner spaces of the frame 110, the two inner spaces being partitioned by the partition unit 111.

The support part 130 may include a plurality of support parts 130 corresponding to a plurality of objects.

The plurality of support parts 130 may be arranged to be slidably movable in each of the two spaces in the frame 110.

As shown in FIGS. 1 and 2, the support part 130 may include a partition wall 131 and a support 133.

The partition wall 131 may support a plurality of objects in the frame 110.

Furthermore, the partition wall 131 may stand vertically within the central hollow space of the frame 110 and be movable along the moving guides 113.

A plurality of partition walls 131 may be configured to support an object M between a partition wall and another partition wall, and a plurality of objects M may be arranged to be spaced at equal intervals by the plurality of partition walls 131.

Furthermore, the plurality of partition walls 131 may support the objectives M and be slidably movable in linear directions, such as one direction and the other direction, together with the objectives M.

During pressing, the pressing unit 300 applies pressure to the plurality of partition walls 131 and moves, thereby pressing the objects M supported between the plurality of partition walls 131, toward one side (X-side) or the other side (Y-side).

The support 133 may be provided at a lower end portion, i.e., the gravitational lower side of each partition wall 131, and bent perpendicular.

The support 133 may support the object M from below, i.e., in a gravitational direction, thereby allowing the standing object M to be supported by the partition wall 131.

The support 133 extends to a length shorter than the thickness of the object M. Accordingly, when the object M is pressed between a plurality of partition walls 131, it is possible to prevent the support 133 from interfering with the partition walls.

The road cell 200 may measure the pressure exerted on the object M pressed by the pressing unit 300.

The road cell 200 and the partition unit 111 intersect each other, and the road cell 200 may be secured to the frame 110 across the central portion of the frame 110.

In other words, the road cell 200 may be provided across the central portion of the space formed through the frame 110.

Furthermore, the road cell 200 is secured across the central portion between the plurality of support parts 130 arranged within the space formed through the frame 110, thereby measuring the pressure in opposite directions.

The support parts 130 may be arranged in a straight line with an equal number in both one side (X side) and the other side (Y side) based on the road cell 200.

As shown in FIGS. 1 and 3, the road cell 200 may be divided from one body into the plurality of measurement units 210.

Furthermore, as another embodiment, the road cell 200 may include a plurality of road cells 200.

One of the plurality of road cells 200 may be provided in one of two spaces divided by the partition unit 111, and measure the pressure exerted on the object M supported by the support part 130.

The other of the plurality of road cells 200 may be provided in the other of the two spaces divided by the partition unit 111, and measure the pressure exerted on the object M supported by the support part 130.

The plurality of measurement units 210 may include four measurement units 210 to divide the road cell 200 into four equal parts.

However, the plurality of measurement units 210 is not limited thereto. As long as the road cell 200 is divided equally, the plurality of measurement units 210 may be four or fewer measurement units 210 or four or more measurement units 210.

Furthermore, the plurality of measurement units 210 of the road cell 200 may independently measure the pressure.

In other words, when the object M is pressed by the pressing unit 300, the road cell 200 may measure partial pressures exerted on the object M corresponding to the positions of the plurality of measurement units 210 divided from each other, and transmit an electric signal to a control unit 400.

Furthermore, the control unit 400 may compare the partial pressures exerted on the object M and calculate the flatness of the object M.

Furthermore, the entire pressure exerted on the object M may be calculated by summing all partial pressures exerted on the object M and dividing the sum by 4.

The pressing unit 300 may exert pressure on the object supported by the support part 130 of the tray body 100.

The pressing unit 300 may include a power unit 310, a rotating shaft 330, and a movable pressing unit 350.

As shown in FIGS. 1 and 4, the power unit 310 may include a plurality of power units 310, and the plurality of power units 310 may be provided on one of the opposite end portions of the tray body 100 and spaced apart from each other.

The power unit 310 may be a power device capable of generating power by a power source, such as an electric motor.

FIG. 4 shows four power units 310, but the power units 310 are not limited thereto. The plurality of power units 310 may be provided to correspond to measuring units 210.

As an embodiment, when four measuring units 210 are provided, four power units 310 may be provided to correspond to the positions of the four measuring units 210.

Furthermore, the plurality of power units 310 may be provided symmetrically with respect to the central portion C of one end portion of the tray body 100.

The plurality of power units 310 may be provided at an edge portion of one end portion of the tray body 100.

The plurality of power units 310 may be operated independently.

In other words, the plurality of power units 310 may differ in each power, thereby exerting the different partial pressures on the object M to correspond to the power units 310.

Two of the plurality of power units 310 may provide rotational force to the rotating shaft 330, which is arranged in one of the two spaces divided by the partition unit 111.

Furthermore, the other two of the plurality of power units 310 may provide rotational force to the rotating shaft 330, which is arranged in the other of the two spaces divided by the partition unit 111.

The rotating shaft 330 may transmit the rotational force from the power unit 310 to the movable pressing unit so that the movable pressing unit 350 may move linearly and press the object.

The rotating shaft 330 may include a plurality of rotating shafts 330 to correspond to a plurality of power units 310.

Furthermore, the plurality of rotating shafts 330 may be connected to the plurality of power units 310 and receive rotational forces from the plurality of power units 310.

The rotating shaft 330 may have screw threads formed on the circumferential surface, and extend from a first end portion to a second end portion of the tray body 100.

The rotating shaft 330 may be connected to the power unit 310 provided at an edge of a first end portion of the tray body 100 and extend linearly to a second end portion of the tray body 100.

The rotating shaft 330 may be rotatably connected to the tray body 100.

The movable pressing unit 350 connected to the rotating shaft 330 moves forward or rearward by the rotational force of the rotating shaft 330 to press the frontmost and rearmost support parts 130 of the plurality of support parts 130 toward the road cell 200. Accordingly, the plurality of support parts 130 may slide along with the movable pressing unit 350 to press the object M or release the pressure.

The movable pressing unit 350 may include a pair of movable pressing units 350, and the pair of movable pressing units 350 may be provided at each of the first and second end portions of the tray body 100.

Each movable pressing unit 350 may be a plate body, but is not limited thereto. The movable pressing unit 350 is not limited in shape as long as it can move inward of the frame 110 and press the object M supported by the support part 130.

The pair of movable pressing units 350 may be connected to the rotating shaft 330 by ball nuts (not shown).

Furthermore, the pair of movable pressing units 350 may move linearly forward and rearward by converting the rotational force of the rotating shaft 330 into linear motion through the ball nuts.

Furthermore, the pair of movable pressing units 350 may move linearly in different directions simultaneously through the ball nuts connected to the rotating shaft 330.

In other words, the pair of movable pressing units 350 may be connected to the first and second end portions of the rotating shaft 330, respectively.

Furthermore, the pair of movable pressing units 350 may move linearly in opposite directions by the rotational force of the rotating shaft 330, thereby moving toward or away from each other.

When the pair of movable pressing units 350 may move toward each other, the object M supported by the support part 130 may be pressed toward the road cell 200 secured across the central portion of the frame 110.

Accordingly, the road cell 200 may measure the pressure exerted on the object M pressed at each side of the road cell 200.

FIG. 5 is a flowchart showing a method for operating the clamping tray according to the embodiment of the present disclosure.

Hereinbelow, the method for operating a clamping tray according to the embodiment of the present disclosure will be described in detail with reference to the accompanying drawings.

As shown in FIG. 5, according to the embodiment of the present disclosure, the method for operating a clamping tray may include: accommodating of objects, by supporting the objects by the support part of the tray body so that the objects are arranged symmetrical to each other with the road cell located therebetween, S1; pressing the objects supported by the support part, by the pressing unit, from opposite end portions of the tray body toward the road cell, S2; measuring the pressures, by the road cell, the pressures being applied on the objects pressed at the both spaces of the road cell, S3; and adjusting power of the pressing unit in response to the pressures measured by the road cell, and pressing the objects, S4.

The accommodating of objects at S1 may be performed by supporting a plurality of objects by the support parts arranged at both spaces of the road cell and allowing the objects to stand upright.

The accommodating of objects at S1 may be performed by accommodating the same number of objects in both spaces of the road cell.

The pressing of an object at S2 may be performed, using the pressing unit, by pressing the plurality of objects accommodated in both spaces of the road cell from opposite end portions of the tray body 100 toward the road cell.

The pressing of an object at S2 may be performed by pressing each of different portions of the object with the power of the plurality of independently operated power units of the pressing unit.

The measuring of pressure at S3 may be performed by measuring partial pressures by the plurality of measurement units arranged at the road cell to correspond to the different portions of the object that are pressed by the plurality of power units of the pressing unit.

In other words, the measuring of pressure at S3 may be performed by measuring the upper and lower pressures on the object by a plurality of measurement units independently measuring the pressures when the object is divided into upper and lower sections in the direction of gravity.

Otherwise, the measuring of pressure at S3 may be performed by measuring the left and right pressures of the object by the plurality of measurement units, which measure the pressures independently.

Otherwise, the measuring of pressure at S3 may be performed by measuring the upper, lower, left, and right pressures of the object by the plurality of measurement units that independently measure the pressures.

The adjusting of power at S4 may be performed by adjusting the power of the power units according to the pressures measured by the road cell, and adjusting the pressure exerted on the object by the power units.

The adjusting of power at S4 may be performed by adjusting the power of the plurality of power units of the pressing unit to correspond to the partial pressures of the object that are measured by the plurality of measurement units, thereby allowing the movable pressing unit to press the object with the power of the power units.

In other words, the adjusting of power at S4 may be performed by adjusting the partial pressures of the object measured by the plurality of measurement units to fit to a preset pressure set by the fabricator's needs.

Otherwise, the adjusting of power at S4 may be performed by increasing the power of one power unit, which supplies power to a portion of the object that is pressed less than other portions of the object, so that the entire flatness of the object can be uniform.

Otherwise, the adjusting of power at S4 may be performed by lowering the power of one power unit, which supplies power to a portion of the object that is pressed further than other portions of the object, so that the entire flatness of the object can be uniform.

Hereinabove, the present disclosure has been described in detail through specific embodiments. The embodiments are provided to specifically describe the present disclosure, but the present disclosure is not limited thereto. Within the technical spirit of the present disclosure, it will be apparent that various modifications or changes are possible by those skilled in the art, and all modifications, equivalents, or alternatives of the present disclosure fall within the scope of the present disclosure.

What is claimed is:

1. A clamping tray comprising:
a tray body having a support part capable of supporting a plurality of objects;
a road cell provided across the support part of the tray body, and capable of measuring pressure; and
a pressing unit configured to press the plurality of objects supported by the support part, from opposite ends of the tray body toward the road cell.

2. The clamping tray of claim 1, wherein the tray body comprises:
a frame forming an outer frame; and
a partition unit arranged across a central portion of the frame from a first side to a second side and dividing an inner space of the frame into two spaces.

3. The clamping tray of claim 2, wherein the road cell is secured across the frame perpendicular to the partition unit, and configured to measure pressure exerted on both sides.

4. The clamping tray of claim 3, wherein the road cell is divided into a plurality of measurement units, and each measurement unit is configured to individually measure pressure.

5. The clamping tray of claim 4, wherein the plurality of measurement units includes four measurement units to uniformly quarter the road cell.

6. The clamping tray of claim 5, wherein the pressing unit is provided at one of both end portions of the tray body, spaced apart from another pressing unit, and includes a plurality of power units.

7. The clamping tray of claim 6, wherein the plurality of power units includes four power units to correspond to the measurement units, and is arranged symmetrically on a central portion of an end of the tray body.

8. The clamping tray of claim 7, wherein the plurality of power units is operated individually from each other.

9. The clamping tray of claim 6, further comprising:
a rotating shaft receiving rotating power from each of the power units, having screw threads on a circumferential surface, and extending from a first end portion to a second end portion of the tray body.

10. The clamping tray of claim 9, further comprising:
a movable pressing unit connected to each of a first end portion and a second end portion of the rotating shaft, and configured to move toward each other or in opposite directions by the rotating power of the rotating shaft.

11. A method for operating a clamping tray, the method comprising:
accommodating objects by a support part of a tray body while arranging the objects symmetrically on both sides of a road cell;
pressing, by the pressing unit, the objects supported by the support part from both end portions of the tray body toward the road cell;
measuring, by the road cell, pressure exerted on the objects pressed at both sides of the road cell; and
adjusting the power of the pressing unit according to the pressure measured by the road cell, and pressing the objects.

12. The method of claim 11, wherein the measuring of pressure is performed by measuring, by the plurality of measurement units of the road cell, partial pressures corresponding to each object pressed by the pressing unit.

13. The method of claim 12, wherein the adjusting of power is performed by adjusting the power of the plurality of power units of the pressing unit differently according to the partial pressures measured by the plurality of measurement units, and pressing the object.

14. The method of claim 13, wherein the adjusting of power is performed by increasing the power of one power unit that supplies the pressure to a portion of the object where a partial pressure of the object measured by the plurality of measurement units is lower than other portions, and by lowering the power of another power unit that supplies the pressure to a portion of the object where a partial pressure of the object measured by the plurality of measurement units is higher than other portions, thereby adjusting the entire flatness of the object uniformly.
